(19) United States
(12) Patent Application Publication
(10) Pub. No.: US 2007/0103412 A1
(43) Pub. Date: May 10, 2007

(54) LIQUID CRYSTAL DISPLAY HAVING A VOLTAGE DIVIDER WITH A THERMISTOR

(76) Inventors: Pao-Yun Tang, Tao-Yuan Hsien (TW); Nan-Cheng Huang, Chang-Hua Hsien (TW); Ming-Tien Lin, Taipei Hsien (TW); Lun-Chen Fan, Tao-Yuan Hsien (TW); Tean-Sen Jen, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,067

(22) Filed: Nov. 9, 2005

(51) Int. Cl. G09G 3/36

(52) U.S. Cl. 345/87

(57) ABSTRACT

A liquid crystal display includes a glass substrate, a plurality of pixels formed on the glass substrate for displaying an image according to gamma voltages, a voltage divider installed on a printed circuit board, the voltage divider including a resistor and a thermistor coupled in series with the resistor for generating gamma voltages for the pixels, and a driver IC chip coupled to the pixels and the voltage divider for controlling the voltage divider to generate gamma voltages to the pixels.

### BACKGROUND OF THE INVENTION

1. Field of the Invention

The present invention relates to a liquid crystal display (LCD), and more particularly, to an LCD having a voltage divider with a thermistor.

2. Description of the Prior Art

A conventional liquid crystal display (LCD) comprises an upper transparent substrate, a lower transparent substrate, and liquid crystal molecules are filled between the two transparent substrates. Please refer to FIG. 1, which is a schematic diagram of a lower transparent substrate of a conventional LCD having a chip-on-glass (COG) module structure. The lower transparent substrate, such as a glass substrate 12, comprises a plurality of pixels 14 formed on the glass substrate 12 for displaying an image according to gamma voltages, a voltage divider 20 installed on a printed circuit board (PCB) 19 for generating gamma voltages corresponding to a gamma value for the pixels 14, a driver IC chip 16 installed on the glass substrate 12 and coupled between the voltage divider 20 and the pixels 14 for controlling the voltage divider 20 to generate the gamma voltages, a flexible printed circuit (FPC) 22 for electrically connecting the PCB 19 and the glass substrate 12, and an anisotropic conductive film (ACF) 18 coupled between the driver IC chip 16 and the glass substrate 12 for adhering the driver IC chip 16 to the glass substrate 12. The ACF 18 is a kind of macromolecule material, and serves as media for conduction and interface adhesion of the driver IC chip 16 to the glass substrate 12. The voltage divider 20 comprises a plurality of serially connected resistors 21, 23, 25, 27, 29 all of which have constant resistance, and constant gamma voltages are respectively outputted between two adjacent resistors.

Please refer to FIG. 2, which is a relation diagram between the voltages applied to a pixel 14 and the transmittance of the pixel 14 for a normally white operation mode, where an abscissa represents the voltages, and an ordinate represents the transmittance. The relation between the voltages and the transmittance of the LCD is changed by the temperature. As the LCD operates in a normal temperature environment, the transmittance is varied with the voltages according to a V-T curve 22. As the LCD operates in a higher temperature environment, the transmittance is varied with the voltages according to a V-T curve 26. However, as the LCD operates in a lower temperature environment, the transmittance is varied with the voltages according to a V-T curve 24.

According to the V-T curve 22, if a first gamma voltage V1 is applied to the pixel 14, the pixel 14 has a first transmittance L1 when the LCD operates in a normal temperature environment. However, when the LCD operates in a higher temperature environment, the first gamma voltage V1 is corresponding to a second transmittance L2 according to the V-T curve 26. Similarly, when the LCD operates in a lower temperature environment, the first gamma voltage V1 is corresponding to a third transmittance L3 according to the V-T curve 24. Consequently, the LCD will display different image when receiving the same gray value data in different temperature of environments.

A thermal sensor and a programmable gamma value IC are introduced to the LCD to overcome the above-mentioned problem. The thermal sensor senses the temperature of the LCD, and the programmable gamma value IC selects and provides a set of appropriate gamma voltages corresponding to one of a plurality of gamma values of the programmable gamma value IC according to the temperature sensed by the thermal sensor.

Indeed, the installation of the thermal sensor and the programmable gamma value IC solves the problem. However, the LCD having the thermal sensor and the programmable gamma value IC costs high.

### SUMMARY OF THE INVENTION

It is therefore a primary objective of the claimed invention to provide an LCD having a voltage divider with a thermistor to overcome the above-mentioned problems.

According to the claimed invention, the LCD includes a glass substrate, a plurality of pixels formed on the glass substrate for displaying an image according to gamma voltages, a voltage divider comprising a resistor and a thermistor coupled in series with the resistor for generating gamma voltages for the pixels, and a driver IC chip coupled to the pixels and the voltage divider for controlling the voltage divider to generate gamma voltages to the pixels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an LCD according to the prior art.

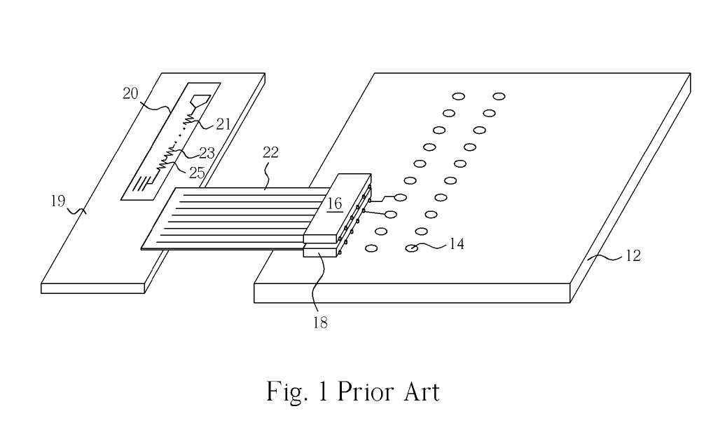

FIG. 2 is a relation diagram between gamma voltages applied to a pixel of the LCD shown in FIG. 1 and the transmittance of the pixel.

FIG. 3 is a schematic diagram of an LCD of a first embodiment according to the present invention.

FIG. 4 is a relation diagram between resistance and temperature of an ACF of the LCD shown in FIG. 3.

FIG. 5 is a schematic diagram of an LCD of a second embodiment according to the present invention.

FIG. 6 is an enlarged side view of a driver IC chip, an ACF and a glass substrate of the LCD shown in FIG. 5.

FIG. 7 is another enlarged side view of a driver IC chip, an ACF and a glass substrate of the LCD shown in FIG. 5.

FIG. 8 is a schematic diagram of the resistance of the thermistor according to the present invention.

FIG. 9 is an enlarged side view of a driver IC chip, an NCF and a glass substrate of the LCD shown in FIG. 5.

FIG. 10 is another enlarged side view of a driver IC chip, an NCF and a glass substrate of the LCD shown in FIG. 5.

### DETAILED DESCRIPTION

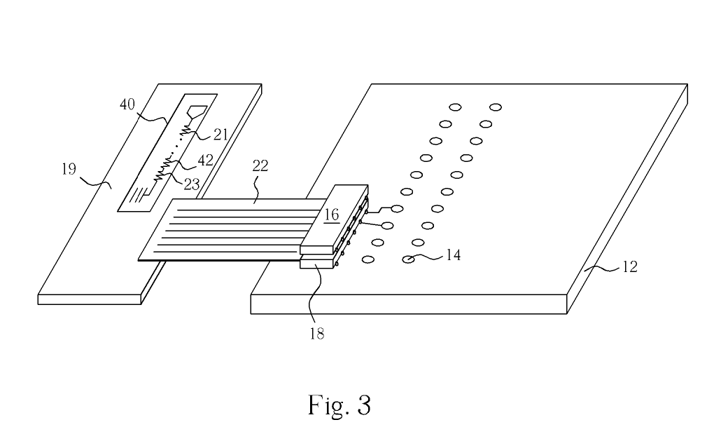

Please refer to FIG. 3, which is a schematic diagram of a lower transparent substrate of an LCD of a first embodiment according to the present invention. The lower transparent substrate, such as a glass substrate 12, comprises the pixels 14, the driver IC chip 16, the ACF 18, and a voltage divider 40 installed on a printed circuit board 19.

Different from the voltage divider 20 of the conventional LCD, the resistance of the resistors 21, 23, 25 of the voltage divider 20 being all constant, the voltage divider 40 of the LCD according to the present invention comprises a plurality of resistors 21, 23, and a thermistor 42 coupled in series with the resistors 21, 23 to replace the resistor 25.

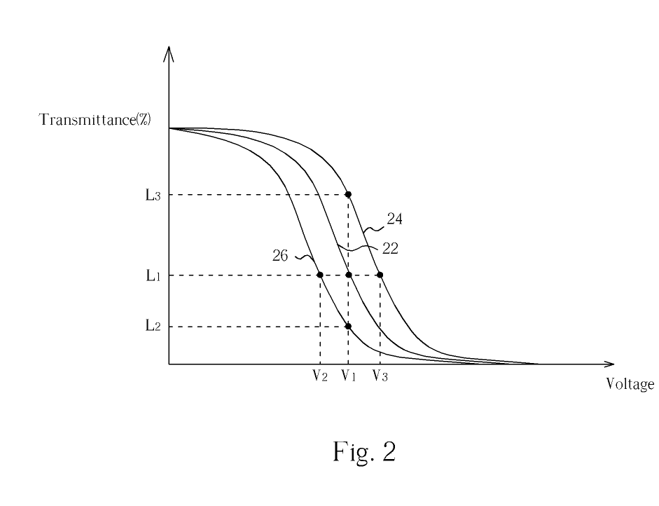

The thermistor 42 varies its resistance as the temperature of the LCD rises. Accordingly, the gamma voltages the voltage divider 40 generates for the pixels 14 vary for fitting in with the V-T curve 26 shown in FIG. 2 as the temperature of the LCD rises. For example, the voltage divider 40 in the normal temperature environment generates the first gamma voltage V1, which is disposed along the first curve 22 and corresponds to the first luminance L1, but generates in the high temperature environment a lower voltage V2 as the first gamma voltage, which is still corresponds to the first luminance L1 according to the curve 26. Consequently, the luminance of the pixels 14 of the LCD keep unchanged with the rising temperature.

The thermistor 42 also varies its resistance as the temperature of the LCD drops. Accordingly, the gamma voltages the voltage divider 40 generates for the pixels 14 vary for fitting in with the V-T curve 24 shown in FIG. 2 as the temperature of the LCD drops. For example, the voltage divider 40 in the normal temperature environment generates the first gamma voltage V1, which is disposed along the first curve 22 and corresponds to the first luminance L1, but generates in the low temperature environment a higher voltage V3 as the first gamma voltage, which is still corresponds to the first luminance L1 according to the curve 24. Consequently, the luminance of the pixels 14 of the LCD keep unchanged with the dropping temperature. Because a higher resistance is needed for generating the gamma voltage as the temperature rising, the thermal coefficient of resistivity of the thermistor 42 is positive.

According to the first embodiment, the voltage divider 40 comprises only one thermistor 42 and the thermistor 42 is coupled in series with the resistors 21, 23. However, a voltage divider of an LCD of the present invention can be designed to comprise more than one thermistor and these thermistors can be coupled in series with the resistors 21, 23.

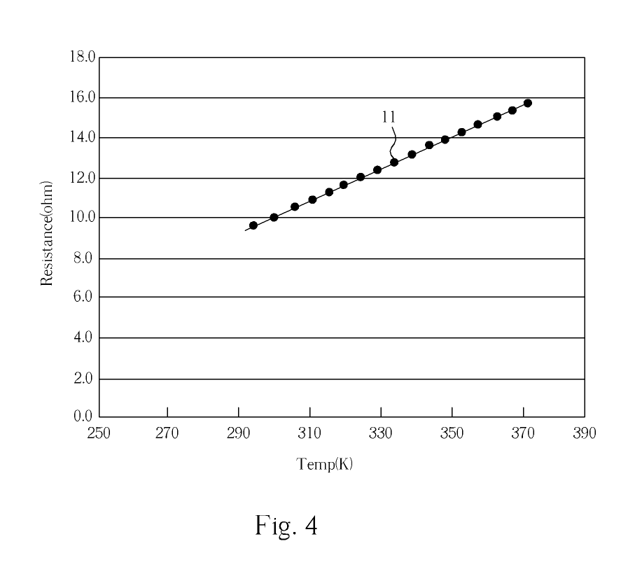

As the media for conduction and interface adhesion of the driver IC chip 16 to the glass substrate 12, the volume of the ACF 18 sandwiched between the driver IC chip 16 and the glass substrate 18 is expanded with the rising temperature, and the ACF 18 has in equivalence a varied resistance. Please refer to FIG. 4, which is a relation diagram between resistance and temperature of the ACF 18, where an abscissa represents the temperature, and an ordinate represents the resistance. It can be seen in FIG. 4 that a resistance-temperature curve 11 of the ACF 18 is approximately linear and the resistance increases as the temperature rises. Therefore, the ACF 18 is suitable to compose the thermistor 42 with positive thermal coefficient of resistivity.

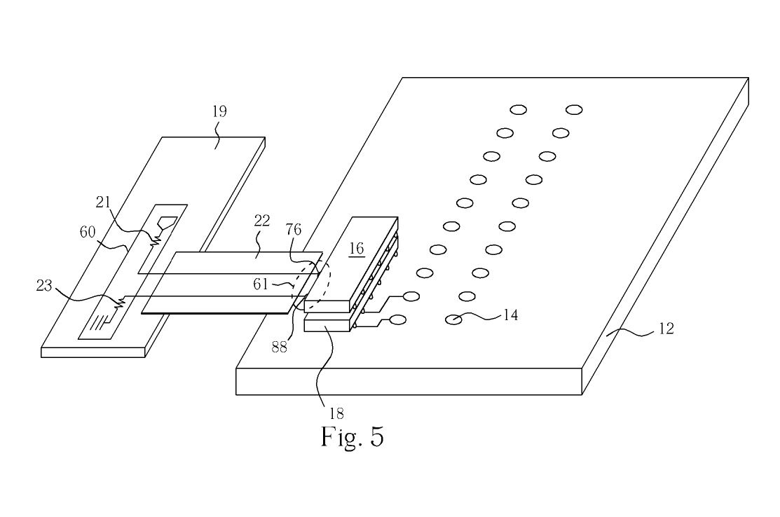

Please refer to FIG. 5, which is a schematic diagram of a lower transparent substrate of an LCD of a second embodiment according to the present invention. The difference between the LCDs of the first embodiment and the second embodiment is the formation of the voltage divider 60.

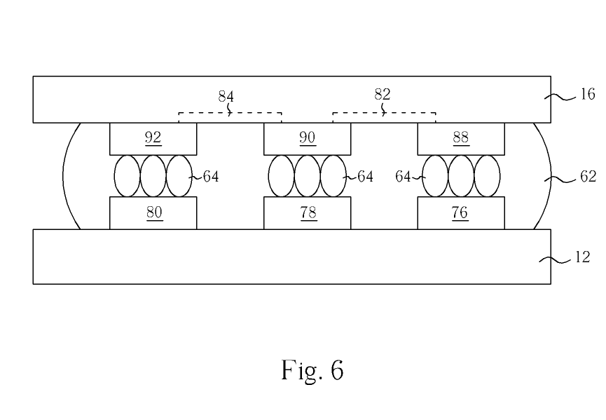

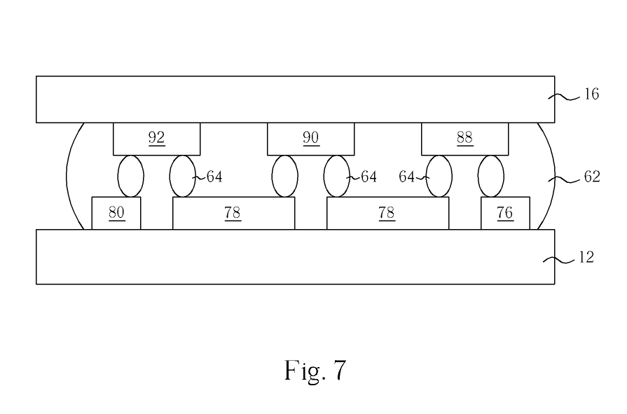

The ACF 18 comprises a layer of resin 62 and a plurality of conductive metal particles 64 blended with the resin 62, as shown in FIG. 6 and FIG. 7, which are an enlarged side view of the driver IC chip 16, the ACF 18, and the glass substrate 12. The ACF 18 is 25 microns in thickness and the conductive particles 64-74 have a particle diameter of 3˜5 microns.

Taking advantage of the ACF 18 that its resistance varies with the rising temperature, as shown in FIG. 6, the voltage divider 60 uses dummy bumps 88, 90, 92 of the driver IC chip 16, dummy pads 76, 78, 80 formed on the glass substrate 12, and the conductive particles 64, which are respectively coupled between the dummy bumps 88, 90, 92 and the dummy pads 76, 78, 80, wherein the interconnecting lines 82 and 84 of the driver IC 16 respectively connect the dummy bumps 88 and 90 and connect the dummy bumps 90 and 92. Furthermore, the dummy pad 76 is connected with the resistor 21 and the dummy pad 80 is connected with the resistor 23, so as to form a thermistor 61, which is shown in FIG. 5. Therefore, the luminance of the image displayed on LCD does not change with the rising temperature. FIG. 7 depicts another bonding structure formed between the dummy bumps 88, 90, 92 of the IC driver 16 and the dummy pads 76, 78, 80 on the glass substrate 12, and no interconnecting line is needed.

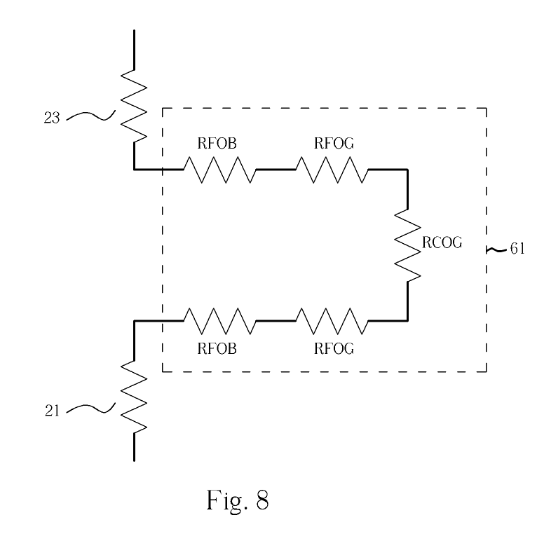

The resistance of the thermistor 61 can be adjusted by the resistance of the connections between the dummy bumps 88, 90, 92 and the dummy pads 76, 78, 80. For example, the resistance of the connection between one dummy bump and one dummy pad, R_{COG}, is about 5-10 ohms, and the thermistor 61 of the voltage divider 60 can have resistance of a multiple of 5-10 ohms by forming a plurality of connections between the dummy bumps and the dummy pads. Furthermore, the connections between the FPC 22 and the PCB 19 (also known as: film on board, FOB) and between the FPC 22 and the glass substrate 12 (also known as: film on glass, FOG) performed by using an ACF respectively have resistance R_{FOB} and R_{FOG}. As shown in FIG. 8, the resistance of the thermistor 61 is a sum of R_{FOB}, R_{COG}, and R_{FOG} and is varied with the operational temperature of the LCD. The thermistor 61 is coupled in series with the resistor 23 having a constant resistance.

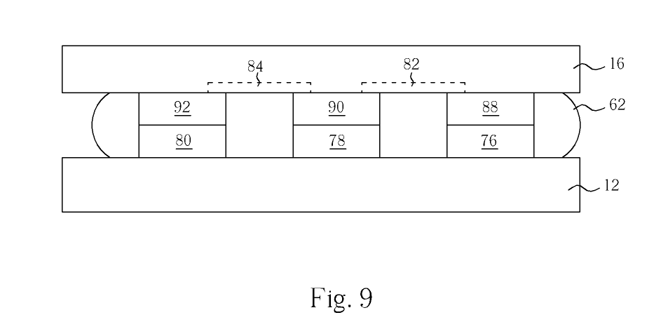

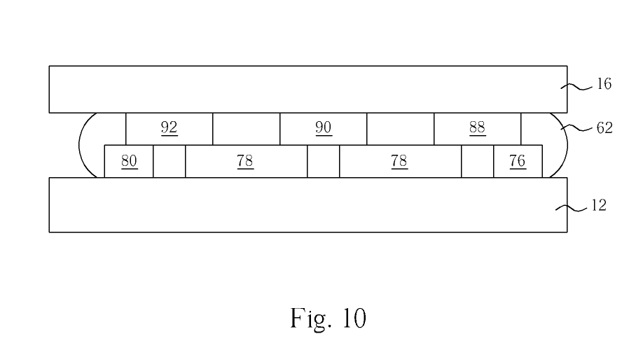

The ACF of the present invention may be replaced by a non-conductive film (NCF), which only comprises a layer of resin 62, and the dummy pads 76, 78, 80 and the dummy bumps 88, 90, 92 are connected by surface contact, as shown in FIG. 9 and FIG. 10. Due to the expansion property of the NCF, the thermistor composed of the NCF also has a positive thermal coefficient of resistivity, which is higher than a thermal coefficient of the thermistor composed of the ACF.

In contrast to the prior art, the present invention can provide an LCD having a voltage divider having a thermistor, which can be composed of a dummy bump of a driver IC chip of the LCD, a conductive particle of an ACF or NCF used to adhere the driver IC chip to a glass substrate of the LCD, and a dummy pad installed on the glass substrate. Therefore, gamma voltages the voltage divider generates for a plurality of pixels of the LCD vary with the operational temperature of the LCD. Consequently, the luminance of the pixels of the LCD corresponding to a gamma voltage keeps unchanged with the rising or falling temperature. The present invention is not limited to the ACF or NCF for bonding the driver IC chip to the glass substrate, and any other conductive glue materials which have their volumes varied with temperature of the LCD can be applied. The present invention is not limited to a thermistor with positive thermal coefficient of resistivity, either. According to display characteristics of the LCD, a thermistor with negative thermal coefficient of resistivity may be used for generating gamma voltages.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD) comprising:
a glass substrate;
a plurality of pixels formed on the glass substrate for displaying an image according to gamma voltages;
a voltage divider comprising a resistor and a thermistor coupled in series with the resistor for generating gamma voltages for the pixels; and
a driver IC chip coupled to the pixels and the voltage divider for controlling the voltage divider to generate gamma voltages to the pixels.

2. The LCD of claim 1 wherein a glue material bonding the driver IC chip to the glass substrate composes a portion of the thermistor, and a volume of the glue material sandwiched between the driver IC chip and the glass substrate is varied with a temperature of the LCD.

3. The LCD of claim 2 wherein the glue material is an anisotropic conductive film (ACF).

4. The LCD of claim 2 wherein the glue material is a non-conductive film (NCF).

5. The LCD of claim 2 wherein a dummy bump of the driver IC chip is electrically connected with a dummy pad of the glass substrate through the glue material.

6. The LCD of claim 5 wherein the voltage divider is installed on a printed circuit board (PCB), and a flexible printed circuit (FPC) is used for electrically connected the printed circuit board (PCB) and the glass substrate.

7. The LCD of claim 6 wherein a resistance of the thermistor is a sum of the resistance of the connection between the dummy bump and the dummy pad, the resistance of the connection between the PCB and the FPC, and the resistance of the connection between the FPC and the glass substrate.

8. The LCD of claim 1 wherein the thermistor has positive thermal coefficient of resistivity.

9. The LCD of claim 1 wherein the thermistor has negative thermal coefficient of resistivity.

10. The LCD of claim 3 wherein the ACF is 25 microns in thickness and comprises a plurality of conductive particles with a particle diameter of 3˜5 microns.

11. The LCD of claim 5 wherein the resistance of the thermistor is adjusted by the resistance of the connection between the dummy bump of the driver IC chip and the dummy pad of the glass substrate through the glue material.

12. The LCD of claim 2 wherein the thermistor using an NCF as a glue material has a higher thermal coefficient of resistivity than the thermistor using an ACF as a glue material.
